(19) United States
(12) Patent Application Publication
(10) Pub. No.: US 2025/0372909 A1
(43) Pub. Date: Dec. 4, 2025

(54) ELECTRICAL CONNECTOR WITH TERMINAL POSITION ASSURANCE DEVICE

(71) Applicants: APTIV CONNECTION SYSTEMS (NANTONG) LTD., Jiangsu (CN); APTIV ELECTRICAL CENTERS (SHANGHAI) CO. LTD., Shanghai (CN)

(72) Inventors: Xiaoxian TIAN, Shanghai (CN); Haifei GUAN, Shanghai (CN)

(21) Appl. No.: 19/215,797

(22) Filed: May 22, 2025

(30) Foreign Application Priority Data
Jun. 3, 2024 (CN) 202410712833.4

(51) Int. Cl. H01R 13/436; H01R 13/506

(52) U.S. Cl. CPC H01R 13/4361; H01R 13/506

(57) ABSTRACT

An electrical connector includes a housing with a mating portion and a terminal mounting portion, featuring a terminal locking structure at the front and a cable receiving cavity at the rear. The housing comprises multiple terminal channels, including a lateral terminal channel and a middle terminal channel. The terminal locking structure is equipped with a lateral side terminal locking arm positioned on the lateral outside of the lateral terminal channel, and a longitudinal side terminal locking arm located on the longitudinal outside of the middle terminal channel. A terminal position assurance (TPA) device is configured to be mounted on the housing, exerting force on the lateral side terminal locking arm to move its free end towards the terminal channel, and similarly applying force to the longitudinal side terminal locking arm to direct its free end towards the terminal channel, ensuring secure terminal positioning within the connector.

### CROSS-REFERENCE TO RELATED APPLICATION

This application claims benefit of priority to patent application Ser. No. 20241,0712833.4 filed with the China National Intellectual Property Authority on Jun. 3, 2024, the entire disclosure of which is hereby incorporated by reference.

### TECHNICAL FIELD OF THE INVENTION

This disclosure generally relates to electrical connection technology and particularly relates to an electrical connector having a terminal position assurance device.

### BACKGROUND

Traditional electrical connectors have typically employed a variety of mechanisms to ensure secure terminal positioning and reliable electrical connections. One common approach involves the use of a single-piece plastic housing with integrated terminal cavities to hold electrical terminals in place. These housings often rely on friction or simple mechanical interference to maintain terminal position, which can be insufficient in applications subject to vibration or mechanical stress. As a result, electrical terminals may become loose or misaligned, leading to potential connection failures.

Another approach has been the incorporation of additional components, such as terminal position assurance (TPA) devices, which are designed to enhance the retention of electrical terminals within the connector housing. These TPA devices are often separate components that are inserted or attached to the housing after the electrical terminals have been positioned.

Some industrial standards or OEM standards have included a requirement for primary locking reinforcement (PLR). PLRs are often designed as separate component.

However, none of these approaches have provided a comprehensive solution that combines the features described in this disclosure.

### SUMMARY

This disclosure presents an electrical connector in which a terminal position assurance (TPA) device is used to achieve the function of terminal position assurance as well as the function of primary locking reinforcement (PLR), thereby reducing the production cost and the operation time for assembly.

According to one aspect of this disclosure, an electrical connector is proposed. The electrical connector includes a housing, the housing includes a mating portion and a terminal mounting portion, and the terminal mounting portion includes a terminal locking structure at the front and a cable receiving cavity at the rear, the housing includes a plurality of terminal channels, the plurality of terminal channels include a lateral terminal channel and a middle terminal channel, and the terminal locking structure includes a lateral side terminal locking arm located on the lateral outside of the lateral terminal channel, and a longitudinal side terminal locking arm located on the longitudinal outside of the middle terminal channel; and a TPA device, which is to be mounted on the housing, so as to apply a force to the lateral side terminal locking arm to make its free end move towards the terminal channel, and apply a force to the longitudinal side terminal locking arm to make its free end move towards the terminal channel.

In the above-mentioned solution of electrical connector, optionally, the electrical connector includes two TPA devices, which are respectively to be mounted to the left and right sides of the housing.

In the above-mentioned solution of electrical connector, optionally, the plurality of terminal channels are distributed in two rows, the lateral terminal channel includes the leftmost terminal channel and the rightmost terminal channel in the upper row, and the leftmost terminal channel and the rightmost terminal channel in the lower row, and the rest being the middle terminal channels.

In the above-mentioned solution of electrical connector, optionally, the TPA device includes a main frame, and extended pressing plates on the upper and lower sides of the main frame, the main frame is to apply force to the lateral side terminal locking arm, and the extended pressing plate is to apply force to the longitudinal side terminal locking arm.

In the above-mentioned solution of electrical connector, optionally, the TPA device includes a main frame, and extended pressing plates on the upper and lower sides of the main frame, the main frame of the TPA device on the left is used to apply force to the lateral side terminal locking arm on the left and several longitudinal side terminal locking arms on the left, and the main frame of the TPA device on the right is used to apply force to the lateral side terminal locking arm on the right and several longitudinal side terminal locking arms on the right.

In the above-mentioned solution of electrical connector, optionally, the TPA device includes a limit mechanism to prevent the terminal from exiting from the terminal channel through physical interference.

In the above-mentioned solution of electrical connector, optionally, a TPA mounting port is formed on the side of the terminal mounting portion for receiving the TPA device.

In the above-mentioned solution of electrical connector, optionally, wherein the top and bottom walls of the terminal mounting portion extend from the rear to the front, and the left and right walls of the terminal mounting portion extend from the rear to the TPA mounting port in the middle.

In the above-mentioned solution of electrical connector, optionally, the electrical connector further includes a cable retainer, and the cable retainer includes a transversely extending partition beam, and a first row of clamping slots and a second row of clamping slots extending from the partition beam.

In the above-mentioned solution of electrical connector, optionally, the cable retainer is installed behind the cable receiving cavity.

In the above-mentioned solution of electrical connector, optionally, the terminal mounting portion includes a partition section to separate the terminal channel into two rows, and the height of the partition beam and the height of the partition section correspond after the cable retainer is mounted onto the housing.

In the above-mentioned solution of electrical connector, optionally, wherein the top and bottom surfaces of the housing are formed with latching slot, the upper and lower sides of the TPA device are formed with clamping plates, and the end of the clamping plate is provided with a clamping edge matching with the latching slot.

In the above-mentioned solution of electrical connector, optionally, wherein a plurality of latching slots are formed on the top and bottom sides of the housing, wherein the latching slot on the outside is used to define a pre-installation position of the TPA device, and the latching slot on the inside is used to define a final locking position of the TPA device.

In the above-mentioned solution of electrical connector, optionally, wherein the left and right sides of the cable receiving cavity of the housing are respectively provided with a pair of guide rails and a convex part between the pair of guide rails, and the two sides of the cable retainer are provided with a pair of snap parts, which are to be snapped to the convex part between the pair of guide rails.

In the above-mentioned solution of electrical connector, optionally, wherein the TPA device is used as both a terminal secondary locking mechanism and a terminal primary locking reinforcing mechanism.

### BRIEF DESCRIPTION OF THE DRAWINGS

In order to provide a clearer explanation of the embodiments of the present disclosure, a brief introduction will be given to the drawings to be used for depicting the embodiments. It is obvious that the drawings described below are only some embodiments of the present disclosure.

FIG. 1 is of an exploded view of an electrical connector according to some embodiments.

FIG. 2A is an isometric view of the electrical connector housing shown in FIG. 1 according to some embodiments.

FIG. 2B is an isometric view of the electrical connector shown in FIG. 2A according to some embodiments.

FIG. 3A is an isometric view of the electrical connector provided by the embodiment of the disclosure when the TPA device and cable retainer are installed according to some embodiments.

FIG. 3B is another isometric view of the electrical connector shown in FIG. 3A according to some embodiments.

FIG. 4 is a top view of the electrical connector housing shown in FIG. 1 according to some embodiments.

FIG. 5 is a cross-sectional view along the A-A direction provided in FIG. 4 according to some embodiments.

FIG. 6 is a cross-sectional view of the electrical connector shown in FIG. 3A along the Y direction and through the TPA device. according to some embodiments

FIG. 7 is a cross-sectional view of the electrical connector shown in FIG. 3A along the X direction according to some embodiments.

FIG. 8 is an isolates isometric view of the TPA device shown in FIG. 1 according to some embodiments.

### DETAILED DESCRIPTION

The following will provide a clear and complete description of the technical solution of the present disclosure with reference to the accompanying drawings for the embodiments. Obviously, the embodiments being depicted are only some of the embodiments of the present disclosure, not all of them. Based on the embodiments being depicted in this disclosure, all other implementations that would be obtained by those skilled in the art without creative labor are within the scope of protection of this disclosure.

In the description of this disclosure, it should be understood that the terms “center”, “up”, “down”, “front”, “back”, “left”, “right”, “vertical”, “horizontal”, “top”, “bottom”, “inside”, “outside” and other directional or positional relationships indicated are based on the accompanying drawings and are only for the convenience of describing this disclosure and simplifying the description, and do not indicate or imply that the device or component referred to must have such a specific orientation, be constructed and operated in such a specific orientation, and therefore these terms shall not be understood as a limitation of this disclosure.

The terms ““first” and “second” are only used for descriptive purposes and shall not be understood as indicating or implying relative importance or implying the number of technical features indicated. Thus, a feature being defined by “first” and “second” may explicitly or implicitly include one or more additional such features. In the description of this disclosure, unless otherwise specified, the meaning of “multiple” refers to two or more.

In the description of this disclosure, it should be noted that unless otherwise specified and limited, the terms “install”, “connect”, and “couple” should be broadly understood, for example, they may refer to fixed connections, detachable connections, or integral connections; they may refer to a mechanical connection, a direct connection, an indirect connection through an intermediate medium, or an internal communication between two components. For those skilled in the art, the specific meanings of the above terms in this disclosure may be understood according to specific situations.

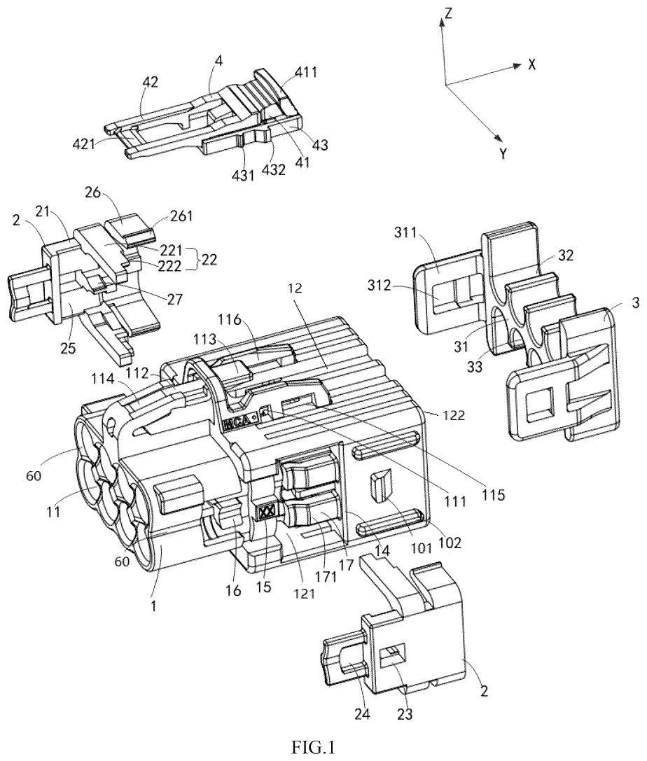

As shown in FIG. 1, the present disclosure provides an electrical connector, which includes a connector housing 1, a TPA (terminal position assurance) device 2, a cable retainer 3, and a CPA (connector position assurance) device 4. As detailed below, when the TPA device 2 is used in conjunction with the connector housing 1, the TPA device 2 not only acts as a terminal secondary locking mechanism but also realizes the function of the terminal primary locking reinforcement (PLR). As detailed below, the cable retainer 3 can further ensure the accuracy of the terminal position.

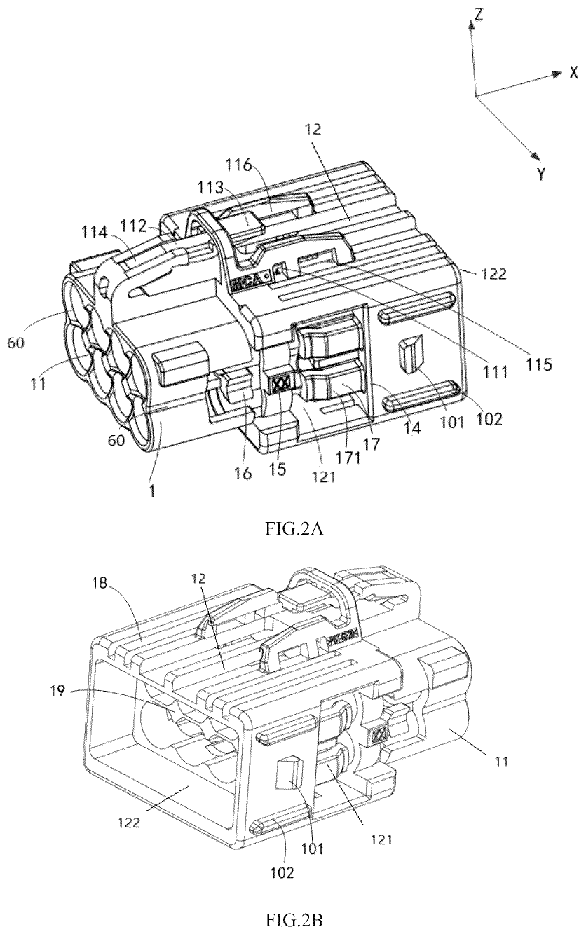

First, the structure of the connector housing 1 (or simply the housing 1) is to be described. As shown in FIG. 1 and FIGS. 2A-2B, the connector housing 1 includes a mating portion 11 at the front and a terminal mounting portion 12 at the rear. The width in the Y direction and the height in the Z direction of the terminal mounting portion 12 are greater than those of the mating portion 11. The terminal mounting portion 12 includes left side walls and right side walls and upper side walls and lower side walls. At the rear of the terminal mounting portion 12, the left side walls and right side walls and the upper side walls and lower side walls enclose a cable receiving cavity 122. At the front of the terminal mounting portion 12, TPA mounting openings 14 are formed on the left side wall and the right side wall respectively, and a terminal locking structure 121 is further formed at a position corresponding to the TPA mounting opening 14 (which will be further described below).

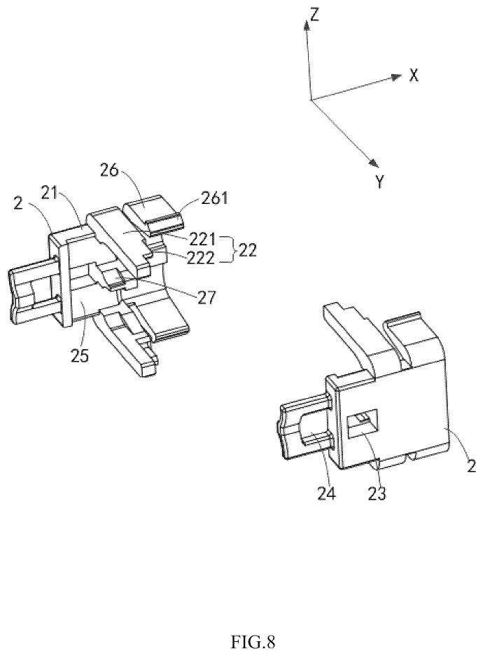

As shown in FIGS. 2A-2B, eight terminal channels 60 are formed in the connector housing 1. As shown in FIG. 2A and FIG. 7, the eight terminal channels 60 run through the mating portion 11, and the eight terminal channels are completely separated from each other in the mating portion 11. Further, as shown in FIG. 2B and FIGS. 6-7, in the front half of the terminal mounting portion 12, the eight terminal channels are divided into two rows, the upper row and the lower row are separated by a partition section 19. Among the four terminal channels in the upper row, the adjacent channels are partially in communication, and among the four terminal channels in the lower row, the adjacent channels are partially in communication.

Specifically, if viewed from the side of the mating portion 11 shown in FIG. 2A, the terminal positions corresponding to the four terminal channels in the upper row can be referred to as terminal positions #1, #2, #3 and #4 from left to right; the terminal positions corresponding to the four terminal channels in the lower row can be referred to as terminal positions #5, #6, #7 and #8 from left to right. In the mating portion 11, terminal positions #1 to #8 are completely isolated from each other. At the terminal locking structure 121, the partition section 19 separates the four terminal positions in the upper row from the four terminal positions in the lower row. However, the terminal positions #1 and #2 are partially in communication, the terminal positions #2 and #3 are partially in communication, the terminal positions #3 and #4 are partially in communication, the terminal positions #5 and #6 are partially in communication, the terminal positions #6 and #7 are partially in communication, and the terminal positions #7 and #8 are partially in communication.

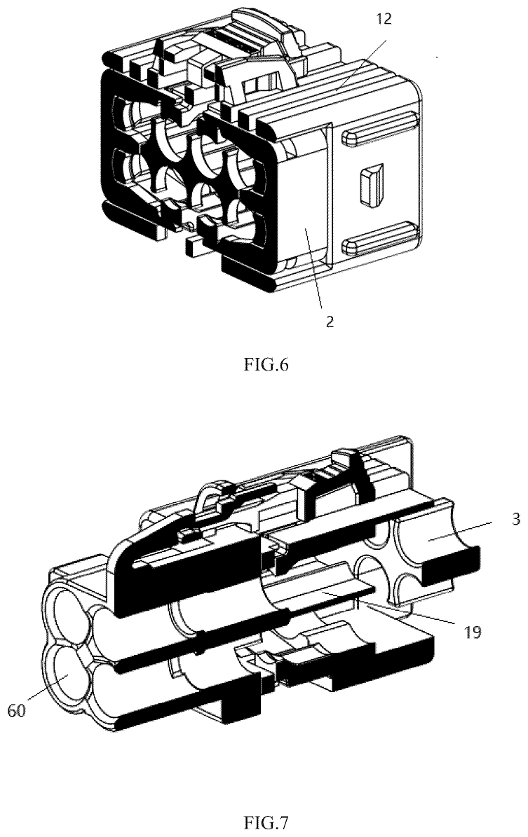

As shown in FIGS. 2A-2B and FIG. 6, the terminal locking structure 121 in the front half of the terminal mounting portion 12 includes two lateral side terminal locking arms 17 formed on the lateral outside of the left two terminal positions (i.e., terminal position 4 and terminal position 8); two lateral side terminal locking arms 17 formed on the lateral outside of the two right terminal positions (i.e. terminal position 1 and terminal position 5); two longitudinal side terminal locking arms 13 formed on the longitudinal outside of the two terminal positions in the middle of the upper row (i.e., terminal positions 2 and 3); two longitudinal side terminal locking arms 13 formed on the longitudinal outside of the two terminal positions in the middle of the lower row (i.e., terminal 6 and terminal 7).

Each terminal locking arm is formed as a cantilever structure, which is located outside the corresponding terminal channel, and the cantilever structure can deform under the action of external force, so that the free end of the cantilever structure moves towards the terminal channel 60, thereby applying additional locking force to the terminals in the terminal channel 60.

The cross-sectional view of FIG. 5 shows the implementation of the longitudinal side terminal locking arm 13 for the terminal position #2 and the terminal position #6. As shown in FIG. 5, the longitudinal side terminal locking arm 13 for the terminal position #6 includes a cantilever 131 and a locking end 132. The locking end 132 partially enters the terminal channel when no force is applied to the longitudinal terminal locking arm 13 and the locking end 132 can be further pushed into the terminal channel after the cantilever 131 is deformed by external force.

The lateral side terminal locking arm 17 may have a structure similar to that of the longitudinal side terminal locking arm 13. For example, as shown in FIG. 1, the lateral side terminal locking arm 17 includes a cantilever 171 and a locking end at the end of the cantilever 171.

The TPA device 2 as shown in FIG. 1 can be installed at the TPA mounting openings 14 on the left and right sides of the connector housing 1, so as to exert a force on the terminal locking arm 13 on the longitudinal side and the terminal locking arm 17 on the lateral side, thereby causing the terminal locking arm to deform and exert an additional locking force on the terminals in the terminal channel 60. In this sense, the TPA device 2 is not only a terminal secondary locking structure (which prevents the terminal from exiting through physical interference), but also serves as a terminal primary locking reinforcement mechanism (which enhances the locking by the connector housing 1 to the terminal).

TPA device 2 is further described below. As shown in FIG. 1 and FIG. 8, the TPA device 2 includes a main frame 21. The main frame 21 is provided with extension pressing plates 22 on upper and lower sides shown in FIG. 1, which are configured to press against the longitudinal side terminal locking arm 13. The extension pressing plate 22 can guide the TPA device 2 to move in the Y direction (transverse) after it is installed into the mounting opening 14. When the TPA device 2 is in the final locking position, the extension pressing plate 22 can sufficiently deform the longitudinal side terminal locking arm 13.

As shown in FIG. 8, the extension pressing plate 22 may include an extension plate 221, and the end of the extension plate 221 is provided with a pressing part 222. When the TPA device 2 is installed in place, the locking end 132 of the longitudinal side terminal locking arm 13 is butted with at least a part of the pressing part 222 of the extension pressing plate 22, so that the free end of the longitudinal side terminal locking arm 13 further moves towards the terminal channel 60, thereby providing an enhanced primary locking effect of the terminal (that is, the locking force between the terminal and the connector housing 1 is enhanced)

As shown in FIG. 8, the pressing part 222 of the extension pressing plate 22 may have a plurality of steps with width differences in the first direction X. In this way, the extension pressing plate 22 will exceed or partially exceed the contour of the outer surface of the connector housing 1 if the terminal is not installed in the correct position, i.e., the TPA device 2 cannot be fully pressed into final position.

As shown in FIG. 1 and FIG. 8, the side of the main frame 21 of the TPA device 2 facing the housing 1 is provided with a contact surface 25 matching with the lateral side terminal locking arm 17. That is, the contact surface 25 of the main frame 21 is to be pressed against the mating surface of the cantilever 171 of the lateral side terminal locking arm 17. When the TPA device 2 is mated with the connector housing 1, the contact surface 25 of the main frame 21 of the TPA device 2 presses against the cantilever 171 of the lateral side terminal locking arm 17, making its free end be closer to the terminal channel 60.

The TPA device 2 may further include a limiting mechanism (including but not limited to the limit portion 27) to prevent the terminal from exiting the terminal channel 60 by physical interference.

A plurality of latching slots 18 extending along the first direction X are formed on the top and bottom surfaces of the terminal mounting portion 12 of the connector housing 1, respectively. The main frame 21 of the TPA device 2 is provided with a clamping plate 26 on its upper and lower sides, and the end of the clamping plate 26 is provided with a clamping edge 261 to be mated with the latching slots 18. Therefore, different installation positions of TPA device 2 can be defined through the latching slots 18. For example, the clamping slot closer to the outside defines the pre-installation position, while the clamping slot closer to the inside defines the final locking position.

In some embodiments, the electrical connector may also include a cable retainer 3 to be connected with the housing 1 in the first direction X. That is, the cable retainer 3 is installed at the rear end of the connector housing 1, thereby partially closing the cable receiving cavity 122.

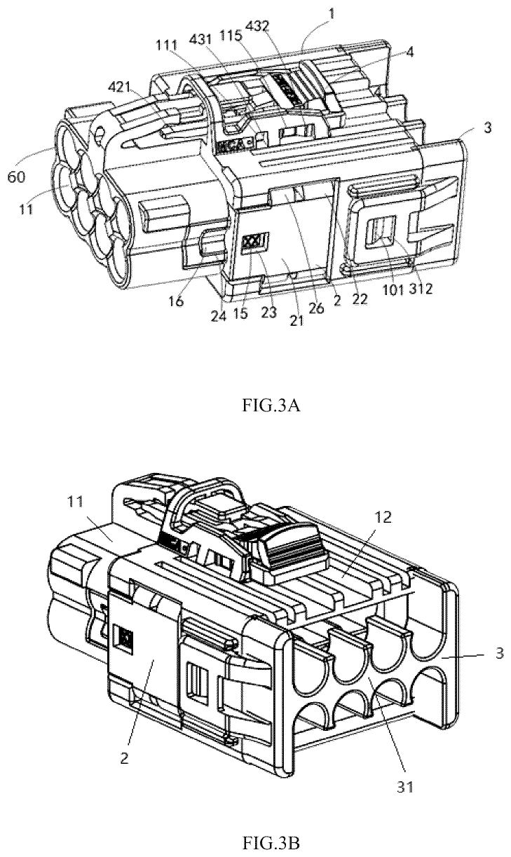

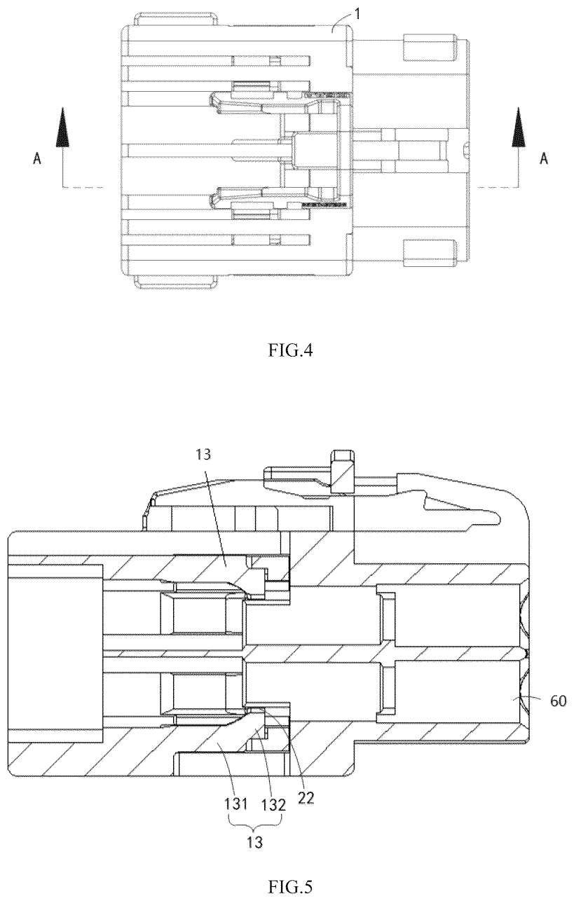

Specifically, as shown in FIG. 1 and FIG. 3B, the cable retainer 3 may include a partition beam 31 extending traversely along the Y direction, a first row of clamping slots 32, and a second row of clamping slots 33 extending from the partition beam 31. The partition beam 31 is spaced from the partition section 19 in the connector housing 1 in the first direction X, that is, the partition beam 31 of the cable retainer 3 and the partition section 19 of the connector housing 1 are located in the same horizontal plane in the first direction X. The first row of clamping slots 32 is in communication with one of the two rows of terminal channels 60, and the second row of clamping slots 33 is in communication with the other of the two rows of terminal channels 60. The cable retainer 3 can bundle the cables in the first row of clamping slots 32 and the second row of clamping slots 33 respectively, so as to comb multiple cables and avoid interleaving.

As shown in FIG. 1, there is a third convex part 101 and two guide rails 102 that are spaced along the third direction Z on each of left and right sides of the housing 1. The third convex part 101 is located in the interval between the two guide rails 102. The partition beam 31 is provided with a snap part 311 on each of left and right sides. The snap part 311 is provided with a third snap hole 312 which is to be engaged with the third convex part 101. The upper and lower sides of the snap part 311 are respectively to be butted with the guide rail 102. Specifically, the two guide rails 102 form a chute so that the cable retainer 3 can slide in or out of the chute under the guidance of the guide rail 102. When the third snap hole 312 latches with the third convex part 101, the fixing effect of the cable retainer 3 and the housing 1 can be achieved. When the third snap hole 312 is separating from the third convex part 101, the chute can define the direction in which the cable retainer is separated from the housing 1, so as to avoid damage to the snap part 311. Therefore, the cable retainer 3 can ensure the position of the terminal in the connector housing 1.

In some embodiments, the electrical connector may also include a CPA device 4. The CPA device 4 includes a main body portion 41, a main locking portion 42, and two side beams 43.

Specifically, the main body portion 41 may serve as the main body of the CPA device 4. Optionally, as an example, the main body part 41 may include a push-pull plate 411, and a user or an external device may facilitate movement of the CPA device 4 by pushing or pulling the push-pull plate 411.

The main locking portion 42 extends from the main body portion 41 in the first direction X and includes a cross beam 421 at one end away from the main body portion 41. The main locking portion 42 may include a first arm and a second arm. The first arm and the second arm extend from the main body 41 in the first direction X. The first arm is separated from the second arm. The first arm and the second arm may be substantially parallel, but the first arm and the second arm may also be formed in such a manner that the distal ends are closer to each other (that is, extending inward) or farther away from each other (that is, extending outward), or in any other appropriate positional relationship. As shown in FIG. 1, the cross beam 421 can extend between the first arm and the second arm.

The main locking portion 42 may have only one arm or more than two arms, or the main locking portion 42 may be a flat plate, a convex plate, a concave plate, or the like with a hole or groove in the central part.

Two side beams 43 are arranged on both sides of the main body portion 41 and extend along the first direction X, and at least a part of each of the two side beams 43 is connected with the main body portion 41. One or both of the two side beams 43 may be formed into a simply supported beam type structure, but any other suitable structure, such as a continuous beam, an extended beam, etc., may also be used.

The side beam 43 includes a first locking structure 431 which protrudes outward from the outside of the side beam 43. The first locking structure 431 may be arranged to be symmetrically positioned on the outer side of each of the side beams 43, as shown in FIG. 1. Although FIG. 1 shows that two first locking structures 431 are included, it may also include only one first locking structure 431 or more than two first locking structures 431.

The side member 43 may also include a second locking structure 432. The first locking structure 431 and the second locking structure 432 are separated in the first direction X. For example, the second locking structure 432 may be located behind the first locking structure 431 in the first direction X. The second locking structure 432 protrudes outward from the outside of each side member 43. The second locking structure 432 may have a projection height greater than the projection height of the first locking structure 431.

The housing 1 may also include locking slots 111 located on both sides of the housing 1 and an unlocking elastic arm 112 located on the top. The unlocking elastic arm 112 may include a free end 113 and a fixed end 114 fixed on the top of the housing 1. The free end 113 can be elastically pressed down, causing the unlocking elastic arm 112 to swing around the fixed end 114. As a non-limiting example, preferably, the connector housing 1 may be made of an elastic material.

The housing 1 may further include pre-locking slots 115. The pre-locking slots 115 are located on both sides of the housing 1 and behind the locking slots 111 in the first direction X. Preferably, the pre-locking slot 115 is a narrow slot extending along the first direction X.

In the above embodiments, the description of each embodiment has its own emphasis. For the part not detailed in one embodiment, please refer to the relevant description of other embodiments.

This disclosure provides a detailed introduction to an electrical connector provided in the embodiments of the present disclosure. Specific examples are provided to explain the principles and implementation methods of the present disclosure. The above embodiments are only used to help understand the method and core idea of the present disclosure. Meanwhile, for a person skilled in the art, based on the ideas of this disclosure, changes in the specific implementation approaches are possible. Therefore, the content of this specification should not be understood as limiting this disclosure.

1. An electrical connector, comprising:
a housing, including a mating portion and a terminal mounting portion having a terminal locking structure at a front and a cable receiving cavity at a rear, the housing further having a plurality of terminal channels a lateral terminal channel and a middle terminal channel, and the terminal locking structure also having a lateral side terminal locking arm located on a lateral outside of the lateral terminal channel, and a longitudinal side terminal locking arm located on the longitudinal outside of the middle terminal channel; and
a TPA device configured to be mounted on the housing, so as to apply a force to the lateral side terminal locking arm to make its free end move towards the terminal channel, and apply a force to the longitudinal side terminal locking arm to make its free end move towards the terminal channel.

2. The electrical connector according to claim 1, wherein the electrical connector comprises two of TPA device, which are mounted to left and right sides of the housing, respectively.

3. The electrical connector according to claim 1, wherein the plurality of terminal channels are distributed in two rows, the lateral terminal channel comprises an upper leftmost terminal channel and an upper rightmost terminal channel in the upper row, and a lower leftmost terminal channel and a lower rightmost terminal channel in the lower row, and a remainder being middle terminal channels.

4. The electrical connector according to claim 1, wherein the TPA device comprises a main frame, and extended pressing plates on upper and lower sides of the main frame, the main frame is to apply force to the lateral side terminal locking arm, and the extended pressing plate is to apply force to the longitudinal side terminal locking arm.

5. The electrical connector according to claim 4, wherein the TPA device comprises a main frame, and extended pressing plates on the upper and lower sides of the main frame, the main frame of the TPA device on a left side is used to apply force to the lateral side terminal locking arm on the left side and several longitudinal side terminal locking arms on the left side, and the main frame of the TPA device on a right side is used to apply force to the lateral side terminal locking arm on the right side and several longitudinal side terminal locking arms on the right side.

6. The electrical connector according to claim 1, wherein the TPA device comprises a limit mechanism to prevent the terminal from exiting from the terminal channel through physical interference.

7. The electrical connector according to claim 1, wherein a TPA mounting port is formed on the side of the terminal mounting portion for receiving the TPA device.

8. The electrical connector according to claim 7, wherein top and bottom walls of the terminal mounting portion extend from the rear to the front and left and wherein right walls of the terminal mounting portion extend from the rear to the TPA mounting port in the middle.

9. The electrical connector according to claim 1, wherein the electrical connector further comprises a cable retainer, and the cable retainer comprises a transversely extending partition beam, and a first row of clamping slots and a second row of clamping slots extending from the partition beam.

10. The electrical connector according to claim 9, wherein the cable retainer is installed behind the cable receiving cavity.

11. The electrical connector according to claim 9, wherein the terminal mounting portion comprises a partition section to separate the terminal channel into two rows, and a height of the partition beam and a height of the partition section correspond after the cable retainer is mounted onto the housing.

12. The electrical connector according to claim 1, wherein top and bottom surfaces of the housing are formed with latching slot, upper and lower sides of the TPA device are formed with clamping plates, and the end of the clamping plate is provided with a clamping edge matching with the latching slot.

13. The electrical connector according to claim 12, wherein a plurality of latching slots are formed on the top and bottom sides of the housing, wherein the latching slot on the outside is used to define a pre-installation position of the TPA device, and the latching slot on an inside is used to define a final locking position of the TPA device.

14. The electrical connector according to claim 9, wherein left and right sides of the cable receiving cavity of the housing are respectively provided with a pair of guide rails and a convex part between the pair of guide rails, and the two sides of the cable retainer are provided with a pair of snap parts, which are to be snapped to the convex part between the pair of guide rails.

15. The electrical connector according to claim 1, wherein the TPA device is used as both a terminal secondary locking mechanism and a terminal primary locking reinforcing mechanism.
